(19) United States
(12) Patent Application Publication
(10) Pub. No.: US 2009/0294367 A1
(43) Pub. Date: Dec. 3, 2009

(54) METHOD AND APPARATUS FOR CONDENSATE DEMINERALIZATION

(76) Inventors: Takeshi IZUMI, Yokohama-shi (JP); Masahiro HAGIWARA, Yokohama-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/470,027

(22) Filed: May 21, 2009

(30) Foreign Application Priority Data
May 22, 2008 (JP) 2008-134408

(51) Int. Cl. B01J 47/04; C02F 1/42

(52) U.S. Cl. 210/686; 210/263

(57) ABSTRACT

A method and an apparatus for performing condensate demineralization which are capable of producing a high-purity treated water containing low concentrations of sulfate ions and nitrate ions derived from TOC eluted from a cation exchange resin and anion exchange resin. A condensate demineralization method for performing a demineralization treatment of a condensate from a boiling-water reactor nuclear power plant using an ion exchange resin, wherein the method employs a mixed bed containing a uniform mixture of a strongly acidic, uniform particle size, gel-type cation exchange resin having an average particle size within a range from 450 to 600 μm and a resin particle existence ratio within a range specified by average particle size ±100 μm of not less than 95%, and a strongly basic type 1 porous anion exchange resin having a Gaussian particle size distribution, the mixed bed is mixed uniformly so that the existence ratio of the anion exchange resin is within ±5% of the design standard value across the entire mixed bed, and the demineralization treatment is performed by bringing the condensate into contact with the mixed bed.

### CROSS REFERENCE TO RELATED APPLICATION

Priority is claimed on Japanese Patent Application No. 2008-134408, filed May 22, 2008, the content of which is incorporated herein by reference.

### BACKGROUND OF THE INVENTION

1. Field of the Invention

The present invention relates to a condensate demineralization method that uses an ion exchange resin to perform demineralization of the condensate from a boiling-water reactor (hereafter abbreviated as BWR) nuclear power plant, and relates more particularly to a method and apparatus for condensate demineralization that enable a high-purity treated water, having both a low concentration of sulfate ions derived from organic impurities eluted from a cation exchange resin and a low concentration of nitrate ions derived from organic impurities eluted from an anion exchange resin, to be obtained in a stable manner over a long period of time.

2. Description of Related Art

In a BWR nuclear power plant, following electric power generation using the steam generated in the nuclear reactor, the steam is cooled using seawater, and the resulting condensate is then treated with ion exchange resins in a condensate demineralization apparatus, before being fed back into the nuclear reactor. This condensate may include seawater components that have seeped into the condensate system, suspended corrosion products generated from plant structural materials and composed mainly of iron oxides (hereafter referred to as “crud”), and ionic impurities. In order to remove these impurities to obtain a high-purity treated water, the nuclear power plant is provided with a condensate demineralization apparatus that uses ion exchange resins to perform a demineralization treatment of the condensate. The ion exchange resins used in the condensate demineralization apparatus include cation exchange resins that adsorb cations, and anion exchange resins that adsorb anions. These exchange resins are typically used in amounts such that the volumetric ratio of cation exchange resin:anion exchange resin is within a range from 1:2 to 3:1, with the resins being used in a mixed state. The particle size distribution for the ion exchange resins used is typically a so-called Gaussian distribution in which the particles sizes exist within a range from 350 to 1,200 μm, and the average particle size is approximately 700 to 800 μm.

In an ion exchange resin, because the ion loading gradually increases and the exchange volume gradually decreases as treatment water is passed through the resin, after usage for a certain period, the resin must be regenerated by passing a chemical through the resin. During this regeneration, the difference in specific gravity between the cation exchange resin and the anion exchange resin is used to perform a backwash separation using an upward flow. In order to enhance the efficiency of this separation, gel-type ion exchange resins having a uniform particle size distribution are available commercially, and these resins are widely used in condensate demineralization apparatus. The reason for their widespread use is because if ion exchange resins having a Gaussian distribution are used, then separation of large particles of the low specific gravity anion exchange resin and small particles of the larger specific gravity cation exchange resins tends to be unsatisfactory, and therefore a more uniform particle size distribution has been employed to improve this separation performance. For these reasons, conventionally, the ion exchange resin used in a condensate demineralization apparatus is a combination of resins having uniform particle sizes, or in the case of a condensate demineralization apparatus in which the frequency with which the regeneration procedure must be conducted is low, is a combination of more conventional Gaussian distribution resins.

The ion exchange resin used in the condensate demineralization apparatus of a nuclear power plant exhibits a superior removal capability for ionic components such as seawater components typified by NaCl introduced from the upstream side of the resin, but organic impurities (hereafter abbreviated as “TOC”) composed mainly of polystyrenesulfonic acids tend to be eluted from the cation exchange resin, and TOC such as trimethylamine tends to be eluted from the anion exchange resin. If the TOC eluted from the cation exchange resin is carried into the nuclear reactor then sulfate ions are generated, whereas the TOC eluted from the anion exchange resin results in the generation of nitrate ions, both of which cause a deterioration in the nuclear reactor water quality.

Accordingly, in order to raise the nuclear reactor water quality to a higher level of purity, the amount of leaked TOC eluted from the demineralization tower filled with the ion exchange resins must be minimized.

Examples of methods that have been proposed to address these problems include a method disclosed in Patent Document 1 (Japanese Unexamined Patent Application, First Publication No. Hei 11-352283), in which a strongly acidic gel-type cation exchange resin is used that has a cross-linking degree of 12 to 16% that is considerably higher than the more typically used cross-linking degree of 8 to 10%, a method disclosed in Patent Document 2 (Japanese Unexamined Patent Application, First Publication No. 2001-314855), in which the anion exchange resin is positioned as the lower layer of the ion exchange resin bed so as to adsorb the TOC eluted from the cation exchange resin, a method disclosed in Patent Document 3 (Japanese Unexamined Patent Application, First Publication No. Hei 8-224579), in which a mixed bed is formed using a strongly acidic gel-type cation exchange resin and a porous anion exchange resin having a Gaussian particle size distribution, and a method disclosed in Patent Document 4 (Japanese Unexamined Patent Application, First Publication No. 2007-64646), in which a mixed bed is formed using a high cross-linking degree gel-type cation exchange resin having a uniform particle size and a gel-type anion exchange resin having a Gaussian distribution.

[Patent Document 1]

Japanese Unexamined Patent Application, First Publication No. Hei 11-352283

[Patent Document 2]

Japanese Unexamined Patent Application, First Publication No. 2001-314855

[Patent Document 3]

Japanese Unexamined Patent Application, First Publication No. Hei 8-224579

[Patent Document 4]

Japanese Unexamined Patent Application, First Publication No. 2007-64646

### SUMMARY OF THE INVENTION

However, even if a strongly acidic gel-type cation exchange resin having a high cross-linking degree is used, extended use over a long period leads to oxidative degradation, and the elution of TOC gradually increases, meaning a deterioration in the water quality compared with the quality obtained when the exchange resin was first used is unavoidable.

Further, in the method in which the anion exchange resin is positioned as the lower layer of the ion exchange resin bed, because the TOC eluted from the cation exchange resin is composed mainly of negatively charged polystyrenesulfonic acids, the TOC can be reduced to a certain degree, but on the other hand, the positively charged TOC such as the trimethylamine eluted from the anion exchange resin cannot be removed by the cation exchange resin, and is therefore leaked from the demineralization column and subsequently undergoes decomposition within the nuclear reactor to generate nitrate ions and the like, leading to a deterioration in the water quality.

Furthermore, because they contain macropores, porous anion exchange resins have a high TOC adsorption capacity, but when combined with a cation exchange resin having a Gaussian distribution, a totally mixed bed cannot be obtained, and the anion exchange resin tends to exist mainly as the upper layer, while the cation exchange resin exists mainly as the lower layer. Accordingly, the organic matter eluted from the cation exchange resin cannot be removed efficiently by the anion exchange resin. Further, in the case of a combination of a gel-type cation exchange resin having a uniform particle size and a gel-type anion exchange resin having a Gaussian distribution, because the TOC removal capability of the Gaussian distribution anion exchange resin is relatively poor, obtaining favorable water quality is impossible.

Furthermore, as described above, a condensate demineralization apparatus uses a cation exchange resin and an anion exchange resin in the form of a mixed bed. This enables the ion exchange reaction within the cation exchange resin and the ion exchange reaction with the anion exchange resin to proceed simultaneously, thereby producing water from the generated hydrogen ions and hydroxide ions, and facilitating the ion exchange reactions. Typically, the cation exchange resin and the anion exchange resin are mixed using air within an ion exchange resin separation and mixing tower or a demineralization tower before water is supplied to the mixed resin. However, total mixing is very difficult regardless of whether the resins have a Gaussian particle size distribution or a uniform particle size distribution, and particularly in the case where both exchange resins have uniform particle size distributions, because the resins are designed to improve the separation operation, mixing is particularly problematic. In the case where both exchange resins have a Gaussian particle size distribution, although mixing occurs more readily than in the case of uniform particle size resins, achieving an ideal mixed state is still difficult, and even if favorable mixing is achieved within the separation and mixing tower, the exchange resins may still separate during subsequent transfer to the demineralization tower, so that even in the case of a combination of exchange resins having a Gaussian particle size distribution, achieving an ideal mixture is still problematic.

The present invention has been developed in light of the above circumstances, and has an object of providing a method and an apparatus for conducting a condensate demineralization treatment within the condensate demineralization apparatus of a BWR nuclear power plant, which are capable of producing a high-purity treated water containing low concentrations of sulfate ions and nitrate ions derived from the TOC eluted from the cation exchange resin and anion exchange resin.

In order to achieve the above object, the present invention provides a condensate demineralization method for performing a demineralization treatment of a condensate from a BWR nuclear power plant using an ion exchange resin, in which

the demineralization treatment of the condensate is performed by bringing the condensate into contact with a mixed bed containing a cation exchange resin and an anion exchange resin, wherein

the cation exchange resin is a strongly acidic, uniform particle size, gel-type cation exchange resin having an average particle size within a range from 450 to 600 μm and a resin particle existence ratio within a range specified by average particle size ±100 μm of not less than 95%,

the anion exchange resin is a strongly basic type 1 porous anion exchange resin having a Gaussian particle size distribution, and

in the mixed bed, the cation exchange resin and the anion exchange resin are mixed uniformly so that the existence ratio of the anion exchange resin is within ±5% of the design standard value across the entire mixed bed.

In the condensate demineralization method of the present invention, a cation exchange resin having a cross-linking degree within a range from 10 to 16% is preferably used as the cation exchange resin.

In the condensate demineralization method of the present invention, a cation exchange resin having a cross-linking degree within a range from 14 to 15% is preferably used as the cation exchange resin.

In the condensate demineralization method of the present invention, the demineralization treatment of the condensate is preferably conducted using a demineralization tower prepared by filling a demineralization tower with a mixture of the cation exchange resin and the anion exchange resin, and uniformly mixing the cation exchange resin and the anion exchange resin so that in the mixed bed formed within the demineralization tower, the existence ratio of the anion exchange resin is within ±5% of the design standard value across the entire mixed bed from the top to the bottom in the bed height direction.

In the condensate demineralization method of the present invention, the demineralization treatment is preferably conducted using a demineralization tower prepared by forming a mixed bed using a strongly acidic, uniform particle size, gel-type cation exchange resin having a cross-linking degree within a range from 10 to 16%, an average particle size within a range from 450 to 600 μm, and a resin particle existence ratio within a range specified by average particle size ±100 μm of not less than 95%, and uniformly mixing this cation exchange resin and the anion exchange resin so that the existence ratio of the anion exchange resin is within ±5% of the design standard value across the entire mixed bed in the bed height direction from the top layer in the demineralization tower to the bottom layer.

Furthermore, the present invention also provides a condensate demineralization apparatus for a boiling-water reactor nuclear power plant that performs a demineralization treatment of a condensate using an ion exchange resin, in which

the condensate demineralization apparatus has a mixed bed containing a cation exchange resin and an anion exchange resin, and the demineralization treatment of the condensate is performed by bringing the condensate into contact with the mixed bed, wherein

the cation exchange resin is a strongly acidic, uniform particle size, gel-type cation exchange resin having an average particle size within a range from 450 to 600 μm and a resin particle existence ratio within a range specified by average particle size ±100 μm of not less than 95%,

the anion exchange resin is a strongly basic type 1 porous anion exchange resin having a Gaussian particle size distribution, and

in the mixed bed, the cation exchange resin and the anion exchange resin are mixed uniformly so that the existence ratio of the anion exchange resin is within ±5% of the design standard value across the entire mixed bed.

In the condensate demineralization apparatus of the present invention, a cation exchange resin having a cross-linking degree within a range from 10 to 16% is preferably used as the cation exchange resin.

In the condensate demineralization apparatus of the present invention, a cation exchange resin having a cross-linking degree within a range from 14 to 15% is preferably used as the cation exchange resin.

The condensate demineralization apparatus of the present invention preferably includes a demineralization tower prepared by filling a demineralization tower with a mixture of the cation exchange resin and the anion exchange resin, and uniformly mixing the cation exchange resin and the anion exchange resin so that in the mixed bed formed within the demineralization tower, the existence ratio of the anion exchange resin is within ±5% of the design standard value across the entire mixed bed from the top to the bottom in the bed height direction.

The condensate demineralization apparatus of the present invention preferably includes a demineralization tower prepared by forming a mixed bed using a strongly acidic, uniform particle size, gel-type cation exchange resin having a cross-linking degree within a range from 10 to 16%, an average particle size within a range from 450 to 600 μm, and a resin particle existence ratio within a range specified by average particle size ±100 μm of not less than 95%, and uniformly mixing this cation exchange resin and the anion exchange resin so that the existence ratio of the anion exchange resin is within ±5% of the design standard value across the entire mixed bed in the bed height direction from the top layer in the demineralization tower to the bottom layer.

According to the present invention, by using a mixed bed prepared by uniformly mixing a strongly acidic, uniform particle size, gel-type cation exchange resin having an average particle size within a range from 450 to 600 μm and a resin particle existence ratio within a range specified by average particle size ±100 μm of not less than 95%, and a strongly basic type 1 porous anion exchange resin having a Gaussian particle size distribution, the mixed bed can be mixed uniformly to form a substantially ideal mixed bed in which the existence ratio of the anion exchange resin is within ±5% of the design standard value across the entire mixed bed, and this mixed state can be retained over a long period of time. Consequently when this mixed bed is used to fill a demineralization tower, a satisfactory amount of the anion exchange resin exists even in the bottom layer of the demineralization tower. Accordingly, the TOC generated from the cation exchange resin is removed by the porous anion exchange resin, and the TOC generated from the porous anion exchange resin is removed by the cation exchange resin, meaning the amount of TOC leaking from the condensate demineralization apparatus can be reduced.

### BRIEF DESCRIPTION OF THE DRAWINGS

FIG. 1 is a schematic structural flow diagram illustrating an example of a BWR nuclear power plant.

FIG. 2 is a schematic structural flow diagram illustrating an embodiment of a condensate demineralization apparatus of the present invention.

FIG. 3 is a schematic structural diagram illustrating the ion exchange resin bed inside a demineralization tower in an embodiment of the present invention.

FIG. 4 is a graph showing the results of an example 1, and illustrates the mixed bed height distribution for the anion exchange resin existence ratio within the prepared mixed bed.

### DESCRIPTION OF THE REFERENCE SYMBOLS

1 Nuclear reactor
2, 3 Turbine
4 Moisture separator
5 Condenser
6 Condensate filtration device
7 Condensate demineralization apparatus
8 Nuclear reactor purification system
10 Demineralization tower
11 Mixed bed
12 Resin strainer
13 Recirculation pump

### DETAILED DESCRIPTION OF THE INVENTION

An embodiment of the present invention is described below with reference to the drawings, although the present invention is in no way limited by this embodiment.

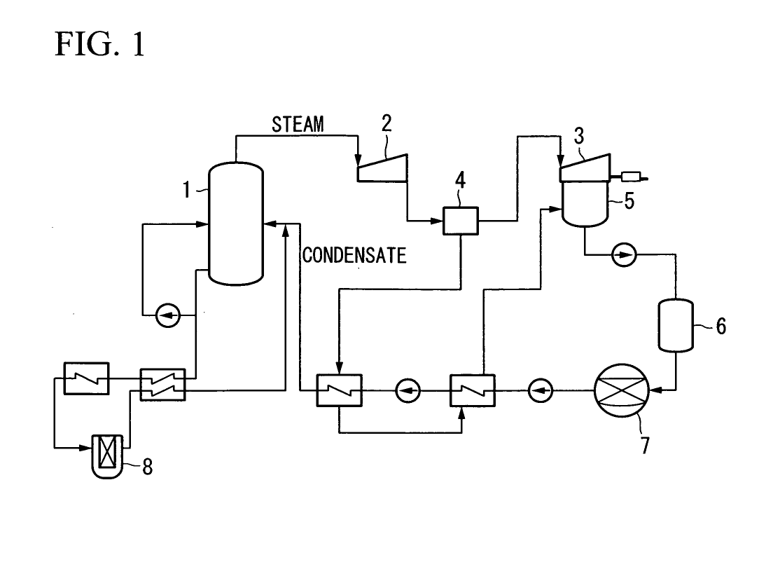

FIG. 1 is a schematic structural flow diagram illustrating an example of a BWR nuclear power plant. In FIG. 1, numeral 1 represents a nuclear reactor, 2 and 3 represent turbines, 4 represents a moisture separator, 5 represents a condenser, 6 represents a condensate filtration device, 7 represents a condensate demineralization apparatus, and 8 represents a nuclear reactor purification system.

In this BWR nuclear power plant, steam is generated in the nuclear reactor 1, and this steam is used to rotate the turbines 2 and 3 to generate electricity. The steam emerging from the turbine 3 is cooled and returned to water by the condenser 5, is subsequently purified in the condensate filtration device 6 and the condensate demineralization apparatus 7, which act as purification units, and is then fed back into the nuclear reactor 1.

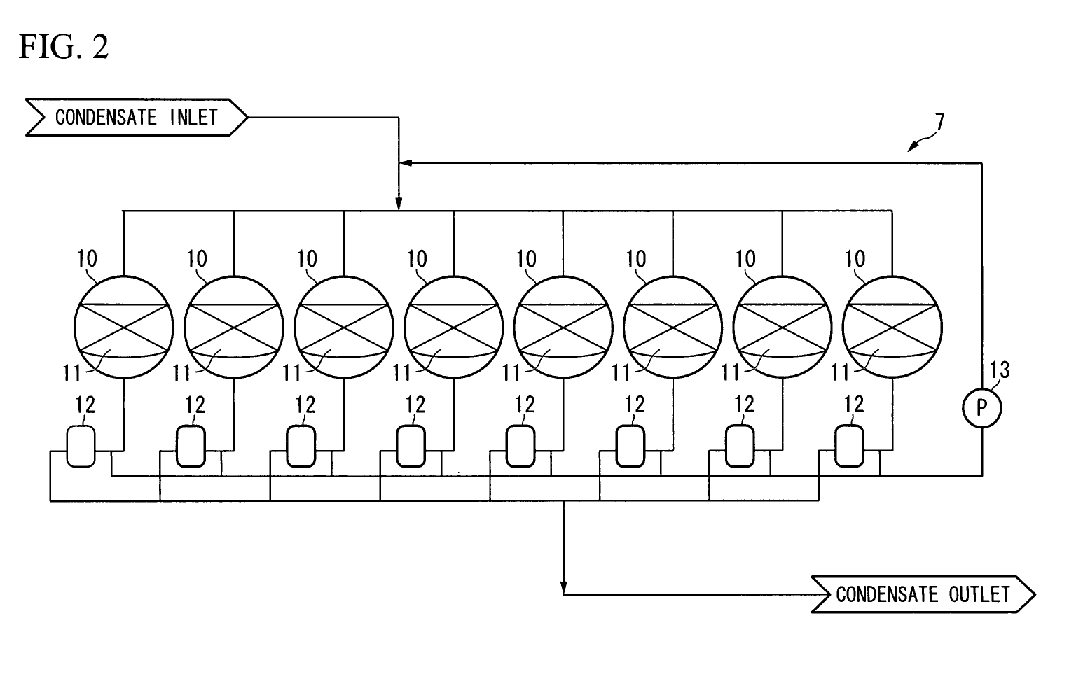

FIG. 2 is a schematic structural flow diagram illustrating an embodiment of a condensate demineralization apparatus of the present invention. In FIG. 2, numeral 7 represents the condensate demineralization apparatus, 10 represents a demineralization tower, 11 represents an ion exchange resin mixed bed, 12 represents a resin strainer, and 13 represents a recirculation pump. In this condensate demineralization apparatus 7, the condensate is treated at a flow rate of 2,000 to 7,000 m³/h, using 3 to 10 demineralization towers 10. A single demineralization tower 10 is filled with 2,000 to 15,000 L of ion exchange resin depending on the treatment flow rate, thus forming the mixed bed 11. The bed height of the mixed bed 11 is within a range from 90 to 200 cm, and is typically approximately 100 cm. Furthermore, the linear flow rate of water through the mixed bed is set within a range from 50 to 200 m/h, and is typically approximately 100 m/h.

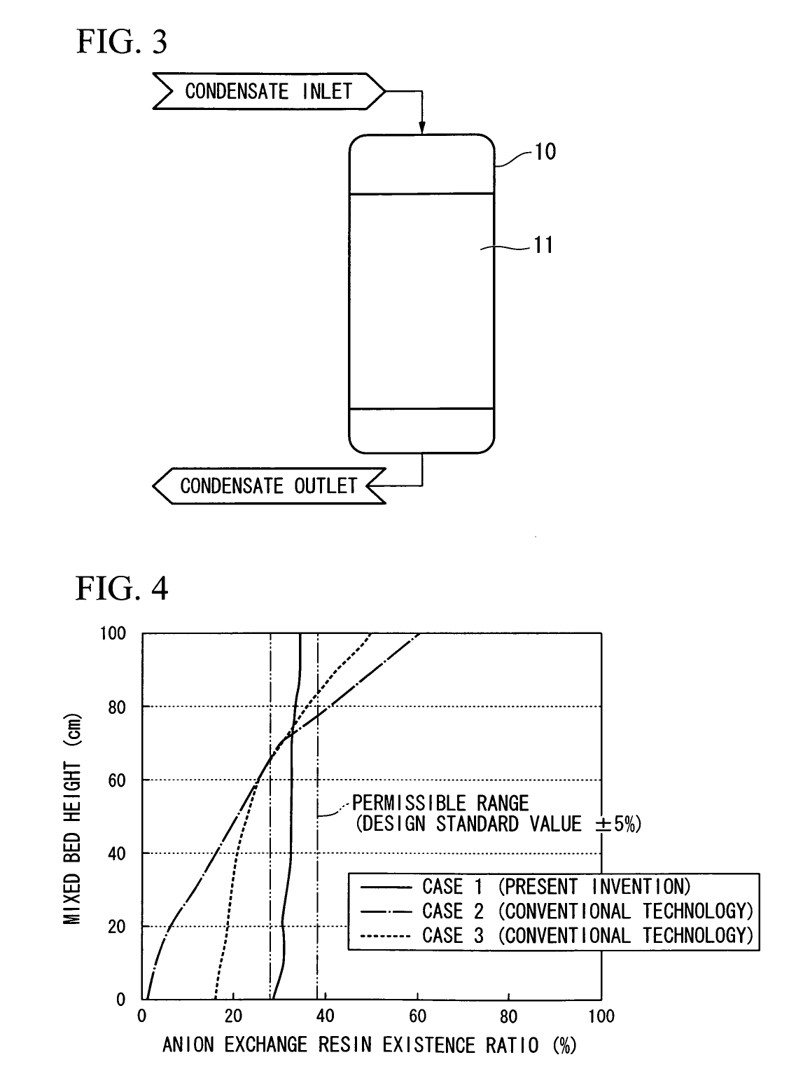

FIG. 3 is a schematic structural diagram illustrating the mixed bed 11 inside the demineralization tower 10 according to the present embodiment. In the condensate demineralization apparatus 7 of this embodiment, the inside of the demineralization tower 10 is filled with a mixed bed 11 prepared by uniformly mixing a strongly acidic, uniform particle size, gel-type cation exchange resin having an average particle size within a range from 450 to 600 μm and a resin particle existence ratio within a range specified by average particle size ±100 μm of not less than 95%, and a strongly basic type 1 porous anion exchange resin having a Gaussian particle size distribution, and the demineralization treatment of the condensate is conducted by bringing the condensate into contact with the mixed bed 11. This mixed bed 11 is mixed uniformly so that the existence ratio of the anion exchange resin is within ±5% of the design standard value across the entire mixed bed.

In the present invention, the expression that “the existence ratio of the anion exchange resin is within ±5% of the design standard value across the entire mixed bed” describes a mixed state wherein if the volumetric ratio of the anion exchange resin relative to the combined total of the cation exchange resin and the anion exchange resin used in preparing the mixed bed is deemed the “design standard value”, then when the actual volumetric ratio of the anion exchange resin is measured for the resin mixture at various portions within the prepared mixed bed, those actual measured (existence ratio) values for the anion exchange resin are within ±5% of the design standard value (for the volumetric ratio) at any point across the entire mixed bed.

FIG. 4 is a graph showing an actual example of the cation exchange resin and anion exchange resin distribution within a mixed bed of bed height 1 m within a condensate demineralization apparatus. In this mixed bed, the cation exchange resin and the anion exchange resin are mixed together in a volumetric ratio of 2:1, meaning the ratio of the anion exchange resin is ideally 33.3% (the design standard value). It is evident from the conventional examples illustrated in FIG. 4 (case 2 and case 3) that when the cation exchange resin has a larger specific gravity than the anion exchange resin, the ratio of the anion exchange resin within the lower layer of the mixed bed is small, whereas the ratio of the anion exchange resin in the upper layer is large. In contrast, in case 1 according to the present invention, where a uniform particle size, gel-type cation exchange resin “Monosphere 545C” having an average particle size of 545 μm and a gel-type anion exchange resin “SBR-C” having a Gaussian distribution were used, the ratio of the anion exchange resin remains within ±5% of the ideal ratio of 33.3% (namely, from 28.3 to 38.3%).

The present invention enables the formation of a “substantially ideal mixed bed” in which the cation exchange resin and the anion exchange resin are mixed uniformly, and are unlikely to separate even over a long period of time. The conditions required for forming a substantially ideal mixed bed are listed below.

(1) Formation of the mixed bed using a strongly acidic, uniform particle size, gel-type cation exchange resin having an average particle size within a range from 450 to 600 μm and a resin particle existence ratio within a range specified by average particle size ±100 μm of not less than 95%, and an anion exchange resin having a Gaussian distribution.

A mixed bed of the present invention, prepared by uniformly mixing a strongly acidic, uniform particle size, gel-type cation exchange resin having an average particle size within a range from 450 to 600 μm and a resin particle existence ratio within a range specified by average particle size ±100 μm of not less than 95%, and an anion exchange resin having a Gaussian distribution is capable of forming a “substantially ideal mixed bed” in which the two exchange resins are mixed uniformly, and are unlikely to separate even over a long period of time.

(2) A difference in terminal velocity between the cation exchange resin and the anion exchange resin of not more than 0.005 m/s.

The separation and mixing properties of the cation exchange resin and the anion exchange resin are determined by the respective terminal velocities of the resin particles. Accordingly, the conditions required for a substantially ideal mixed bed can also be defined using the terminal velocity. When ion exchange resin particles settle out in water, the velocity of those particles reaches a constant value over time, and this constant velocity is known as the terminal velocity. The terminal velocity is determined by factors such as the viscosity and the coefficient of viscosity for the water, and the particle size and specific gravity of the ion exchange resin, and the greater the difference in terminal velocity values, the more easily the exchange resin particles can be separated, whereas the closer the terminal velocity values are, the less likely separation is to occur.

The terminal velocity of a uniform particle size cation exchange resin having an average particle size of 650 μm is approximately 0.025 m/s, and the terminal velocity of a uniform particle size anion exchange resin having an average particle size of 590 μm is approximately 0.013 m/s, meaning these resins separate extremely readily. In contrast, the terminal velocity of an anion exchange resin having a Gaussian distribution in which the particle size distribution is from 350 to 1,180 μm and the average particle size is approximately 700 μm is approximately 0.020 m/s, and the terminal velocity of a uniform particle size cation exchange resin having an average particle size of 545 μm is approximately 0.022 m/s, and in a combination of these two resins, the two exchange resins can be mixed in a substantially ideal mixed state.

The ion exchange resins typically used in condensate demineralization apparatus have so-called Gaussian distributions in which the particle size distribution is distributed across a range from 420 to 1,180 μm, and the specific gravity of the cation exchange resin is typically approximately 1.2, whereas the specific gravity of the anion exchange resin is approximately 1.08. In the ion exchange resin tower of a condensate demineralization apparatus, the cation exchange resin and anion exchange resin are used in a mixed state known as a mixed bed. Because there is a difference in specific gravity between the cation exchange resin and the anion exchange resin, and because a backwash operation is used to separate the two resins and perform a chemical regeneration operation once the mixed bed has been used for a certain period of time, the average particle size of the cation exchange resin is made slightly larger to facilitate the separation of the two resins. Prior to re-use of the ion exchange resins following the chemical regeneration, a mixing operation is conducted using air to re-mix the two resins, but the resulting mixed state cannot be claimed to be a totally mixed state, and is certainly not an ideal mixed state.

In the present invention, by using a uniform particle size gel-type cation exchange resin and a type 1 porous anion exchange resin having a Gaussian distribution, an ideal mixed state can be achieved. In particular, by setting the average particle size for the cation exchange resin to a value within a range from 450 to 600 μm, an ideal mixed state can be achieved in those cases where a typical Gaussian distribution anion exchange resin with an average particle size of approximately 700 μm is used, meaning the TOC generated from the cation exchange resin is removed by the anion exchange resin, and the TOC generated from the anion exchange resin is removed by the cation exchange resin, thereby enabling a reduction in the amount of TOC leaking from the condensate demineralization apparatus.

The cross-linking degree of the uniform particle size gel-type cation exchange resin used in the present invention is preferably within a range from 10 to 16%, and is more preferably from 14 to 15%.

In the present invention, when the resin copolymer is produced using styrene and the cross-linking agent divinylbenzene (DVB) as raw materials, the “cross-linking density” of the ion exchange resin describes the mass ratio of the cross-linking agent DVB within the total mass of raw materials.

The cross-linking degree is one factor that strongly influences the properties of the ion exchange resin, and generally, a resin with a high cross-linking degree has a large exchange capacity but exhibits poor regeneration efficiency, whereas a resin with a low cross-linking degree exhibits the opposite properties. Considering these merits and demerits, a strongly acidic gel-type cation exchange resin having a standard cross-linking degree of 8 or 10% has typically been used. However, a BWR nuclear power plant is usually operated in a non-regenerative operating mode in which chemical regeneration is not conducted, meaning the demerit associated with the poor regeneration efficiency does not apply, and therefore a high cross-linking degree cation exchange resin having superior oxidation resistance is used within the condensate demineralization apparatus.

Examples of the uniform particle size gel-type cation exchange resin used in the present invention include the resins Monosphere 575C and Monosphere 545C marketed by Dow Chemical Japan Ltd.

Examples of the Gaussian distribution type 1 porous anion exchange resin used in the present invention include MSA marketed by The Dow Chemical Company, PA312 marketed by Mitsubishi Chemical Corporation, and IRA900 marketed by Rohm and Haas Japan Co., Ltd. Further, the cation exchange resin may employ a typical ion exchange resin that has been subjected to an operation such as water-sieving to adjust the particle size distribution.

The features of porous anion exchange resins and gel-type anion exchange resins are described below. Particulate ion exchange resins can be broadly classified into two ion exchange resin types depending on the production method used, namely, transparent gel-type ion exchange resins, which are produced by forming a copolymer by suspension polymerization of styrene and divinylbenzene, and subsequently introducing functional groups into this copolymer, and porous ion exchange resins having macropores, which are produced by adding an organic solvent that is insoluble in water but readily dissolves styrene and the like during the suspension polymerization, and then removing the organic solvent following the polymerization. Identifying the two types of resin is extremely simple, as the transparent spheres are gel-type resins, whereas the opaque spheres are porous resins. Besides this visual identification, identification can also be conducted using a stereomicroscope, and when observation is conducted using a transmitted light, resins in which the light is transmitted and the entire resin can be seen are gel-type resins, whereas resins in which the transmitted light is scattered, revealing black areas, are porous resins.

The physical properties of the two resin types are very different, with a gel-type ion exchange resin having an average particle size of several Å and a specific surface area of less than 1 m²/g, and a porous resin having an average particle size of several tens to several hundred Å and a specific surface area of several tens to several hundred m²/g.

In the case of the adsorption of typical ions such as sodium ions and chloride ions, the structure of a gel-type resin presents absolutely no problems, but in the case of materials such as organic substances that have a larger molecular weight than a typical ion, gel-type resins and porous resins exhibit different removal properties due to their different structures.

An anion exchange resin contains quaternary ammonium groups, meaning the resin matrix is positively charged. Accordingly, adsorption of negatively charged organic substances can be expected. In particular, oxidative degradation of the matrix structure of the cation exchange resin can result in the elution of polystyrenesulfonic acids having a molecular weight of several hundred to several tens of thousands. Because these polystyrenesulfonic acids carry a negative charge, adsorption by the anion exchange resin would be expected, but in the case of a gel-type resin, because the average particle size is a small value of only several Å, adsorption is only possible at the surface of the resin particles, and because the surface area is also a small value of less than 1 m²/g, the removal capacity is relatively poor.

In contrast, a porous resin has an average particle size of several tens to several hundred Å and a specific surface area of several tens to several hundred m²/g, which are two or more orders of magnitude larger than the values for a gel-type resin, and therefore these large polystyrenesulfonic acids can be adsorbed at the resin particle surface and then readily incorporated within the interior of the resin particle.

In a BWR nuclear power plant, it is desirable to maintain the nuclear reactor water quality at a high level of purity in order to inhibit corrosion of the structural materials used in the nuclear reactor and maintain the reactor in good condition. The main impurity within the nuclear reactor water is sulfate ions, and the source of these sulfate ions is the TOC generated from the cation exchange resin used in the condensate demineralization apparatus. Moreover, when the water exiting from the condensate demineralization apparatus is supplied to the nuclear reactor, the water volatilization inside the nuclear reactor increases the impurity concentration by a factor of 50- to 100-fold, meaning there is considerable merit to reducing the TOC within the water exiting the condensate demineralization apparatus, even if the degree of this reduction is minimal.

In those cases where the ion exchange resins being used inside the condensate demineralization apparatus are new, the sulfate ion concentration within the nuclear reactor water is typically approximately 1 μg/L, but as the resins are used, oxidative degradation of the cation exchange resin gradually progresses, and the amount of organic impurities eluted from the cation exchange resin increases, until the concentration of the sulfate ions within the reactor water reaches approximately 5 μg/L at the end of the ion exchange resins lifespan. At this point, the ion exchange resin is replaced.

Accordingly, if the amount of TOC leakage from the condensate demineralization apparatus can be reduced, then the sulfate ion concentration within the nuclear reactor water can be reduced, the structural materials of the nuclear reactor can be more easily maintained in good condition, and the usable lifespan of the ion exchange resin can be extended, which is not only advantageous from an economical perspective, but also enables a reduction in the amount of radioactive waste, which is extremely desirable.

Moreover, in recent years there have been considerable demands for further improvements in the purity of the nuclear reactor water in order to enable the structural materials of the nuclear reactor to be more easily maintained in good condition. Various measures have been investigated in order to meet these demands, and the present invention is an extremely effective method in this regard.

### EXAMPLES

A more detailed description of the present invention is presented below using a series of examples, although the present invention is in no way limited by these examples.

The ion exchange resins listed below (all of which are available commercially from Dow Chemical Japan Ltd.) were used in the examples.

Monosphere 545C: a uniform particle size gel-type cation exchange resin with an average particle size of approximately 545 μm

MSA: a Gaussian distribution porous anion exchange resin

HCR-W2: a Gaussian distribution gel-type cation exchange resin

SBR-C: a Gaussian distribution gel-type anion exchange resin

Monosphere 550A: a uniform particle size gel-type anion exchange resin with an average particle size of approximately 590 μm

### Example 1

Using the above uniform particle size resins and Gaussian distribution resins, resin mixing tests were conducted using the following three combinations of resins, thereby comparing the conventional technology with the present invention.

### <Case 1>: (Present Invention)

A mixed bed of the uniform particle size gel-type cation exchange resin Monosphere 545C+the Gaussian distribution porous anion exchange resin MSA.

### <Case 2>: (Conventional Technology 1)

A mixed bed of the uniform particle size gel-type cation exchange resin Monosphere 545C+the uniform particle size gel-type anion exchange resin Monosphere 550A.

### <Case 3>: (Conventional Technology 2)

A mixed bed of the gaussian distribution gel-type cation exchange resin HCR-W2+the Gaussian distribution gel-type anion exchange resin SBR-C.

The cation exchange resin and the anion exchange resin were used in a volumetric ratio of 2/1 to fill a column with an internal diameter of 50 mm to a mixed bed height of 100 cm, and following execution of an air scrambling mixing operation for 5 minutes at an SV value of 20, samples were taken at 5 cm intervals from the top of the ion exchange resin bed downwards, and the mixed state of the cation exchange resin and the anion exchange resin was determined for each sample. The results are shown in FIG. 4.

As is evident from FIG. 4, in the combination of case 1 according to the present invention, the cation exchange resin and the anion exchange resin were mixed substantially uniformly from the top of the mixed bed to the bottom, resulting in what may be termed a substantially ideal mixed bed. As a result, high-purity treated water can be obtained.

### Example 2

Using the above cation exchange resins and anion exchange resins, ion exchange resin beds were formed in accordance with case 4 to case 8 described below. Each ion exchange resin bed was then subjected to a water passage test, and the concentration of eluted TOC was measured.

### <Case 4>

An ion exchange resin bed formed from a mixed bed according to the present invention produced by preparing a totally mixed state of the uniform particle size gel-type cation exchange resin Monosphere 545C and the Gaussian distribution porous anion exchange resin MSA.

### <Case 5>

An ion exchange resin bed composed of two separated layers, with the Gaussian distribution porous anion exchange resin MSA provided as the upper layer, and the uniform particle size gel-type cation exchange resin Monosphere 545C provided as the lower layer.

### <Case 6>

An ion exchange resin bed composed of two separated layers, with the uniform particle size gel-type cation exchange resin Monosphere 545C provided as the upper layer, and the Gaussian distribution porous anion exchange resin MSA provided as the lower layer.

### <Case 7>

An ion exchange resin bed formed from a mixed bed produced by preparing a totally mixed state of the Gaussian distribution gel-type cation exchange resin HCR-W2 and the Gaussian distribution gel-type anion exchange resin SBR-C.

### <Case 8>

An ion exchange resin bed formed from a mixed bed produced by preparing a totally mixed state of the uniform particle size gel-type cation exchange resin Monosphere 545C and the Gaussian distribution gel-type anion exchange resin SBR-C.

Testing was conducted by forming the ion exchange resin beds of the above four cases by using the specified cation exchange resin and anion exchange resin in a volumetric ratio of 2/1 to fill a column with an internal diameter of 25 mm, subsequently supplying pure water having a temperature of 45° C. and a conductivity of 0.006 mS/m to each column at a water linear flow rate of 120 m/h, and measuring the concentration levels of impurities within the treated water.

The TOC eluted from the cation exchange resin is mainly polystyrenesulfonic acid and the TOC eluted from the anion exchange resin is mainly trimethylamine, and therefore the treated water was irradiated with ultraviolet light to effect oxidative degradation of the organic substances, and the concentration levels of the thus generated sulfate ions and nitrate ions were measured. The results are shown in Table 1.

TABLE 1

| | | | Treated water sulfate | Treated water nitrate |
|---|---|---|---|---|
| | Cation exchange resin + | | ion concentration | ion concentration |
| | Anion exchange resin | Mixed state | (μg/L) | (μg/L) |
| Case 4 | Monosphere 545C + MSA | Totally mixed state | 2.0 | 1.0 |
| Case 5 | Monosphere 545C + MSA | 2 separate layers 1 | 20.0 | 1.0 |
| Case 6 | Monosphere 545C + MSA | 2 separate layers 2 | 1.0 | 10.0 |
| Case 7 | HCR-W2 + SBR-C | Totally mixed state | 7.0 | 1.0 |
| Case 8 | Monosphere 545C + SBR-C | Totally mixed state | 5.0 | 1.0 |

The results in Table 1 reveal that the highest sulfate ion concentration was detected in case 5 because only the cation exchange resin exists within the lower layer, whereas in contrast, the highest nitrate concentration was detected in case 6 because only the anion exchange resin exists within the lower layer.

If case 7 which represents the conventional technology is compared with case 4 according to the present invention, then it is evident that whereas sulfate ions were detected at a comparatively high concentration in case 7 according to the conventional technology, the concentration levels for both sulfate ions and nitrate ions were low for the present invention.

Furthermore, if case 8 which used a non-porous anion exchange resin is compared with case 4 of the present invention, then it is evident that case 4 according to the present invention yields a lower sulfate ion concentration. These results confirm that the present invention represents the most superior technology.

What is claimed is:

1. A condensate demineralization method for performing a demineralization treatment of a condensate from a boiling-water reactor nuclear power plant using an ion exchange resin, in which
said demineralization treatment of said condensate is performed by bringing said condensate into contact with a mixed bed comprising a cation exchange resin and an anion exchange resin, wherein
said cation exchange resin is a strongly acidic, uniform particle size, gel-type cation exchange resin having an average particle size within a range from 450 to 600 μm and a resin particle existence ratio within a range specified by average particle size ±100 μm of not less than 95%,
said anion exchange resin is a strongly basic type 1 porous anion exchange resin having a Gaussian particle size distribution, and
in said mixed bed, said cation exchange resin and said anion exchange resin are mixed uniformly so that an existence ratio of said anion exchange resin is within ±5% of a design standard value across all of said mixed bed.

2. A condensate demineralization method according to claim 1, wherein a cross-linking degree of said cation exchange resin is within a range from 10 to 16%.

3. A condensate demineralization method according to claim 1, wherein a cross-linking degree of said cation exchange resin is within a range from 14 to 15%.

4. A condensate demineralization method according to claim 1, wherein said demineralization treatment of said condensate is conducted using a demineralization tower prepared by filling a demineralization tower with a mixture of said cation exchange resin and said anion exchange resin, and uniformly mixing said cation exchange resin and said anion exchange resin so that in a mixed bed formed within said demineralization tower, an existence ratio of said anion exchange resin is within ±5% of a design standard value across all of said mixed bed from top to bottom in a bed height direction.

5. A condensate demineralization method according to claim 2, wherein said demineralization treatment of said condensate is conducted using a demineralization tower prepared by filling a demineralization tower with a mixture of said cation exchange resin and said anion exchange resin, and uniformly mixing said cation exchange resin and said anion exchange resin so that in a mixed bed formed within said demineralization tower, an existence ratio of said anion exchange resin is within ±5% of a design standard value across all of said mixed bed from top to bottom in a bed height direction.

6. A condensate demineralization method according to claim 3, wherein said demineralization treatment of said condensate is conducted using a demineralization tower prepared by filling a demineralization tower with a mixture of said cation exchange resin and said anion exchange resin, and uniformly mixing said cation exchange resin and said anion exchange resin so that in a mixed bed formed within said demineralization tower, an existence ratio of said anion exchange resin is within ±5% of a design standard value across all of said mixed bed from top to bottom in a bed height direction.

7. A condensate demineralization method according to claim 4, wherein a cross-linking degree of said cation exchange resin is within a range from 10 to 16%.

8. A condensate demineralization method according to claim 5, wherein a cross-linking degree of said cation exchange resin is within a range from 10 to 16%.

9. A condensate demineralization method according to claim 6, wherein a cross-linking degree of said cation exchange resin is within a range from 10 to 16%.

10. A condensate demineralization apparatus for a boiling-water reactor nuclear power plant that performs a demineralization treatment of a condensate using an ion exchange resin, in which
said condensate demineralization apparatus has a mixed bed comprising a cation exchange resin and an anion exchange resin, and said demineralization treatment of said condensate is performed by bringing said condensate into contact with said mixed bed, wherein
said cation exchange resin is a strongly acidic, uniform particle size, gel-type cation exchange resin having an average particle size within a range from 450 to 600 μm and a resin particle existence ratio within a range specified by average particle size ±100 μm of not less than 95%,
said anion exchange resin is a strongly basic type 1 porous anion exchange resin having a Gaussian particle size distribution, and
in said mixed bed, said cation exchange resin and said anion exchange resin are mixed uniformly so that an existence ratio of said anion exchange resin is within ±5% of a design standard value across all of said mixed bed.

11. A condensate demineralization apparatus according to claim 10, wherein a cross-linking degree of said cation exchange resin is within a range from 10 to 16%.

12. A condensate demineralization apparatus according to claim 10, wherein a cross-linking degree of said cation exchange resin is within a range from 14 to 15%.

13. A condensate demineralization apparatus according to claim 10, comprising a demineralization tower prepared by filling a demineralization tower with a mixture of said cation exchange resin and said anion exchange resin, and uniformly mixing said cation exchange resin and said anion exchange resin so that in a mixed bed formed within said demineralization tower, an existence ratio of said anion exchange resin is within ±5% of a design standard value across all of said mixed bed from top to bottom in a bed height direction.

14. A condensate demineralization apparatus according to claim 11, comprising a demineralization tower prepared by filling a demineralization tower with a mixture of said cation exchange resin and said anion exchange resin, and uniformly mixing said cation exchange resin and said anion exchange resin so that in a mixed bed formed within said demineralization tower, an existence ratio of said anion exchange resin is within ±5% of a design standard value across all of said mixed bed from top to bottom in a bed height direction.

15. A condensate demineralization apparatus according to claim 12, comprising a demineralization tower prepared by filling a demineralization tower with a mixture of said cation exchange resin and said anion exchange resin, and uniformly mixing said cation exchange resin and said anion exchange resin so that in a mixed bed formed within said demineralization tower, an existence ratio of said anion exchange resin is within ±5% of a design standard value across all of said mixed bed from top to bottom in a bed height direction.

16. A condensate demineralization apparatus according to claim 13, wherein a cross-linking degree of said cation exchange resin is within a range from 10 to 16%.

17. A condensate demineralization apparatus according to claim 14, wherein a cross-linking degree of said cation exchange resin is within a range from 10 to 16%.

18. A condensate demineralization apparatus according to claim 15, wherein a cross-linking degree of said cation exchange resin is within a range from 10 to 16%.
